(19) United States
(12) Patent Application Publication
(10) Pub. No.: US 2025/0138359 A1
(43) Pub. Date: May 1, 2025

(54) Display Module and Display Device

(71) Applicants: HEFEI BOE DISPLAY TECHNOLOGY CO., LTD., Hefei, Anhui (CN); BOE TECHNOLOGY GROUP CO., LTD., Chaoyang District, Beijing (CN)

(72) Inventors: Chaoyue Wang, Beijing (CN); Jianming Liu, Beijing (CN); Wenbo Dong, Beijing (CN); Xunwang Yu, Beijing (CN); Huiming Wang, Beijing (CN); Xinyue He, Beijing (CN); Peng Zhao, Beijing (CN); Xiuqin Yang, Beijing (CN); Mingqi Zhang, Beijing (CN); Jing Ma, Beijing (CN)

(21) Appl. No.: 18/693,627

(22) PCT Filed: Feb. 14, 2023
(86) PCT No.: PCT/CN2023/075934

§ 371 Date: Mar. 20, 2024

(51) Int. Cl. G02F 1/1335; G02B 5/02; G02B 5/04; G02F 1/1333

(52) U.S. Cl. CPC G02F 1/133507; G02B 5/0242; G02F 1/133388; G02B 5/04; G02F 2202/28

(57) ABSTRACT

A display module includes a display assembly, a first composite prism film and a first adhesive layer. The display assembly includes a first display panel having a display area and a first polarizer disposed on a non-display surface of the first display panel. The first composite prism film includes a first prism layer disposed on a side of the first polarizer away from the first display panel and a haze layer located between the first prism layer and the first polarizer, and the haze layer includes a first bonding agent layer and a plurality of first diffusion particles dispersed in the first bonding agent layer. The first adhesive layer bonds the haze layer to the first polarizer. An orthographic projection of the first adhesive layer on a plane where the first display panel is located covers at least the display area.

### CROSS-REFERENCE TO RELATED APPLICATION

This application is the United States national phase of International Patent Application No. PCT/CN2023/075934, filed Feb. 14, 2023, the disclosure of which is hereby incorporated by reference in its entirety.

### BACKGROUND OF THE INVENTION

### Field of the Invention

The present disclosure relates to the field of display technologies, and in particular, to display modules and display devices.

### Description of Related Art

A display device (e.g., mobile phone or virtual reality device) includes a display module and a middle frame. The display module includes a display panel and a plurality of optical films that are stacked in layers. The plurality of optical films and the display panel in the display module are snapped on the middle frame. However, the optical film is prone to expansion, resulting in a gap between the display panel and the optical film. As a result, the thickness of the middle frame increases, so as to make it difficult for the display device to be ultra-thin and ultra-light. Therefore, the research on the ultra-thin and ultra-light display device has great significance.

### SUMMARY OF THE INVENTION

In an aspect, a display module is provided. The display module includes a display assembly, a first composite prism film and a first adhesive layer. The display assembly includes a first display panel and a first polarizer. The first polarizer is disposed on a non-display surface of the first display panel, and the first display panel has a display area. The first composite prism film includes a first prism layer and a haze layer. The first prism layer is disposed on a side of the first polarizer away from the first display panel. The haze layer is disposed on the first prism layer and located between the first prism layer and the first polarizer. The haze layer includes a first bonding agent layer and a plurality of first diffusion particles dispersed in the first bonding agent layer. The first adhesive layer bonds the haze layer in the first composite prism film to the first polarizer in the display assembly. An orthographic projection of the first adhesive layer on a plane where the first display panel is located covers at least the display area.

Optionally, the plurality of first diffusion particles include a plurality of first particles, and the plurality of first particles are dispersed in the first bonding agent layer. In at least some of the plurality of first particles, a portion of each first particle is embedded in the first bonding agent layer, and a remaining portion of each first particle protrudes from the first bonding agent layer and is bonded to the first adhesive layer.

Optionally, the haze layer has a sampling area, an orthographic projection of the sampling area on the first display panel is located within the display area of the first display panel, and a unit length of the sampling area is at least greater than or equal to 150 μm. The plurality of first diffusion particles further include a plurality of second particles, and the plurality of second particles are dispersed in the first bonding agent layer. In the sampling area, a distance between a lowest first particle and the first polarizer is smaller than a distance between the second particles and the first polarizer. The lowest first particle is a first particle farthest away from the first polarizer among all the first particles protruding from an upper surface of the first bonding agent layer.

Optionally, the distance between the lowest first particle and the first polarizer is smaller than a distance between a highest second particle and the first polarizer. The highest second particle is a second particle closest to the first polarizer among all the second particles protruding from the upper surface of the first bonding agent layer.

Optionally, an average particle size of the plurality of first particles is greater than an average particle size of the plurality of second particles.

Optionally, hardness of the first particles is greater than hardness of the second particles, a total mass of the plurality of first particles is greater than a total mass of the plurality of second particles; and the hardness of the first particles is greater than or equal to 20 MPa.

Optionally, a ratio of a total mass of the plurality of first particles to a mass of the first bonding agent layer is greater than or equal to 60%.

Optionally, a haze of the haze layer is greater than or equal to 70%, and a haze of the first adhesive layer is less than 1%.

Optionally, the first display panel includes sub-pixels in a plurality of columns. The first prism layer includes a plurality of first prism units. In a first direction, a ratio of a dimension of a first prism unit to a dimension of a sub-pixel is equal to n, n is a positive number except for 0.5 and positive integers, and the first direction is an extending direction of a long side of the first display panel.

Optionally, the first prism layer includes a plurality of columns of first prism units. An angle between an extending direction of the first prism units and a first direction which is an extending direction of a long side of the first display panel is greater than or equal to 30° and less than or equal to 150°.

Optionally, the first composite prism film further includes a first back coating layer, and the first back coating layer is disposed on a side of the first prism layer away from the first display panel. The first back coating layer includes a second bonding agent layer and a plurality of second diffusion particles dispersed in the second bonding agent layer. A haze of the first back coating layer is greater than or equal to 90%, or the haze of the first back coating layer is in a range of 35% to 70%.

Optionally, in a case where the haze of the first back coating layer is in the range of 35% to 70%, a material of the second diffusion particles includes an organic material, and a particle size of a second diffusion particle is in a range of 5 μm to 10 μm.

Optionally, in a case where the haze of the first back coating layer is greater than or equal to 90%, the second diffusion particles include sixth particles and fifth particles, a material of the sixth particles is an organic substance, and a material of the fifth particles includes a metal oxide; and a particle size of a second diffusion particle is less than or equal to 4 μm.

Optionally, the first composite prism film further includes a first base material layer and a first brightness enhancement layer. The first base material layer is disposed on a side of the first prism layer away from the first polarizer. The first brightness enhancement layer is disposed between the first base material layer and the first prism layer and is in contact with the first base material layer. A refractive index of the first brightness enhancement layer is smaller than a refractive index of the first base material layer.

Optionally, the first composite prism film further includes a polarizing brightness enhancement layer, and the polarizing brightness enhancement layer is disposed between the first prism layer and the haze layer.

In another aspect, a first composite prism film is provided. The first composite prism film includes a first prism layer and a haze layer. The haze layer is disposed on the first prism layer. The haze layer includes a first bonding agent layer and a plurality of first diffusion particles dispersed in the first bonding agent layer.

In yet another aspect, a display module is provided. The display module includes a second display panel and a second composite prism film, and the second display panel has a display area. The second composite prism film includes a polarizing unit, a second adhesive layer, a second prism layer and a third adhesive layer. The polarizing unit is disposed on a non-display surface of the second display panel and includes a polarizing layer and a first support layer that are stacked. The second adhesive layer bonds the second display panel to the polarizing unit. An orthographic projection of the second adhesive layer on a plane where the second display panel is located covers at least the display area. The second prism layer is disposed on a side of the polarizing unit away from the second display panel. The second prism layer has a plurality of first light exit surfaces, and the first light exit surfaces are inclined relative to the plane where the second display panel is located, and the first light exit surfaces are uneven surfaces. The third adhesive layer is disposed between the polarizing unit and the second prism layer and bonded to the second prism layer. Haze treatment is performed on one of the second adhesive layer, the first support layer and the third adhesive layer.

Optionally, a haze of one of the second adhesive layer, the first support layer and the third adhesive layer is in a range of 45% to 60%, and hazes of other two are less than 1%.

Optionally, the polarizing unit further includes a second support layer. The second support layer, the polarizing layer and the first support layer are stacked in sequence, and a haze of the second support layer is less than 1%.

Optionally, a haze of the first light exit surfaces is in a range of 40% to 50%.

Optionally, a first light exit surface has a plurality of recessed portions and/or a plurality of protrusion portions.

Optionally, the second prism layer includes a plurality of second prism units, a second prism unit includes a prism body and a plurality of third diffusion particles, and the prism body has a bottom surface and inclined surfaces connected to the bottom surface. The plurality of third diffusion particles are pasted on the inclined surfaces of the prism body to become first light exit surfaces of the second prism layer.

Optionally, the plurality of third diffusion particles include a plurality of third particles and a plurality of fourth particles, a material of the third particles is an organic substance, and a material of the fourth particles is a metal oxide.

Optionally, among the plurality of third diffusion particles, a ratio of a total mass of the plurality of fourth particles to a total mass of the plurality of third particles is in a range of 30% to 50%.

Optionally, the second prism layer includes a plurality of second prism units, a second prism unit has a second light exit surface and two first light exit surfaces, and the second light exit surface is connected to the two first light exit surfaces. The second light exit surface is parallel to the plane where the second display panel is located. The second light exit surface is bonded to the third adhesive layer.

Optionally, the second composite prism film further includes a second back coating layer. The second back coating layer is disposed on a side of the second prism layer away from the second display panel. The second back coating layer includes a third bonding agent layer and a plurality of fourth diffusion particles dispersed in the third bonding agent layer. A haze of the second back coating layer is greater than or equal to 90%, or the haze of the second back coating layer is in a range of 35% to 70%.

Optionally, in a case where the haze of the second back coating layer is in the range of 35% to 70%, a material of the fourth diffusion particles is an organic material, and a particle size of a fourth diffusion particle is in a range of 5 μm to 10 μm.

Optionally, in a case where the haze of the second back coating layer is greater than or equal to 90%, the fourth diffusion particles include eighth particles and seventh particles, a material of the eighth particles is an organic substance, and a material of the seventh particles is a metal oxide; and a particle size of a fourth diffusion particle is less than or equal to 4 μm.

Optionally, the second composite prism film further includes a third base material layer and a second brightness enhancement layer. The third base material layer is disposed on a side of the second prism layer away from the polarizing unit. The second brightness enhancement layer is disposed between the third base material layer and the second prism layer and in contact with the third base material layer. A refractive index of the second brightness enhancement layer is smaller than a refractive index of the third base material layer.

In yet another aspect, a second composite prism film is provided. The second composite prism film includes a polarizing unit, a second adhesive layer, a second prism layer and a third adhesive layer. The polarizing unit includes a polarizing layer and a first support layer that are stacked. The second adhesive layer is bonded to the polarizing unit. The second prism layer is disposed on a side of the polarizing unit away from the second adhesive layer. The second prism layer has a plurality of first light exit surfaces, and the first light exit surfaces are inclined relative to a plane where the second adhesive layer is located, and the first light exit surfaces are uneven surfaces. The third adhesive layer is disposed between the polarizing unit and the second prism layer and bonded to the second prism layer. A haze of one of the second adhesive layer, the first support layer and the third adhesive layer is in a range of 45% to 60%.

In yet another aspect, a display device is provided. The display device includes a frame and the display module as described above. The display module has a display surface, a back surface, and a side surface connecting the display surface and the back surface. The frame has a first support surface. The back surface of the display module is bonded to the first support surface. The first support surface is parallel to the plane where the display panel is located.

Optionally, the frame includes a frame body and a first shielding portion. The frame body has the first support surface. The first shielding portion is disposed on and protrudes from the frame body, exposes the first support surface, and surrounds the side surface of the display module.

Optionally, in a thickness direction of the display module, a dimension of the first shielding portion is greater than or equal to a thickness of the display module.

Optionally, the display device further includes a second shielding portion. The second shielding portion is bonded to the side surface of the display module, and the first shielding portion surrounds the second shielding portion.

Optionally, the entire frame is located on a side of the back surface of the display module away from the display surface. The display device further includes a third shielding portion, and the third shielding portion is bonded to the side surface of the display module.

Optionally, the third shielding portion extends from the side surface of the display module to the first support surface.

Optionally, the display panel in the display module has a non-display area, and a width of the first support surface is smaller than a width of the non-display area.

Optionally, the display device further includes a backlight layer, and the backlight layer is disposed on the frame and located on a side of the back surface of the display module away from the display surface. The display module further includes a back coating layer disposed on a side of the first prism layer away from the first display panel. The backlight layer and the display module have an air layer therebetween, and a haze of the back coating layer in the display module is greater than or equal to 90%.

Optionally, the display device further includes a backlight layer, and the backlight layer is disposed on the frame and located on a side of the back surface of the display module away from the display surface. The display module further includes a back coating layer disposed on a side of the first prism layer away from the first display panel. The display device further includes a diffusion sheet disposed between the backlight layer and the display module, and a haze of the back coating layer in the display module is in a range of 35% to 70%.

Optionally, the display device further includes a prism film disposed between the backlight layer and the display module, and the prism film and the display module have a gap therebetween.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams, but are not limitations on an actual size of a product, an actual process of a method and an actual timing of a signal to which the embodiments of the present disclosure relate.

FIG. 1 is a structural diagram of a display device, in accordance with some embodiments;

FIG. 2 is a schematic diagram of a first display module, in accordance with some embodiments;

FIG. 3 is a structural diagram of a first display module, in accordance with some embodiments;

FIG. 4 is a structural diagram of a display assembly, in accordance with some embodiments;

FIGS. 5, 8 and 10 are each a structural diagram of a first composite prism film, in accordance with some embodiments;

FIGS. 6 and 9 are each a physical map of a first composite prism film, in accordance with some embodiments;

FIG. 7 is an enlarged view of an area Q in FIG. 5;

FIG. 11 is a structural diagram of a first display panel and a first prism layer;

FIG. 12 is a structural diagram of another first display panel and another first prism layer;

FIG. 13 is a structural diagram of a second display module, in accordance with some embodiments;

FIG. 14 is a structural diagram of a second composite prism film, in accordance with some embodiments;

FIG. 15 is a structural diagram of a polarizing unit, in accordance with some embodiments;

FIG. 16 is a structural diagram of another polarizing unit, in accordance with some embodiments;

FIGS. 17 to 20 are each a structural diagram of a second prism layer, in accordance with some embodiments; and

FIGS. 21 to 24 are each a structural diagram of a display device, in accordance with some embodiments.

### DESCRIPTION OF THE INVENTION

Technical solutions in some embodiments of the present disclosure will be described clearly and completely with reference to the accompanying drawings below. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive, i.e., “including, but not limited to”. In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics described herein may be included in any one or more embodiments or examples in any suitable manner.

Hereinafter, the terms such as “first” and “second” are used for descriptive purposes only, and are not to be construed as indicating or implying the relative importance or implicitly indicating the number of indicated technical features. Thus, features defined with “first” or “second” may explicitly or implicitly include one or more of the features. In the description of the embodiments of the present disclosure, the term “a plurality of” or “the plurality of” means two or more unless otherwise specified.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The phrase “applicable to” or “configured to” as used herein indicates an open and inclusive expression, which does not exclude devices that are applicable to or configured to perform additional tasks or steps.

The term such as “parallel”, “perpendicular” or “equal” as used herein includes a stated condition and a condition similar to the stated condition. A range of the similar condition is within an acceptable range of deviation. The acceptable range of deviation is determined by a person of ordinary skill in the art in view of measurement in question and errors associated with the measurement of a particular quantity (i.e., limitations of the measurement system). For example, the term “parallel” includes absolute parallelism and approximate parallelism, and an acceptable range of deviation of the approximate parallelism may be a deviation within 5°; the term “perpendicular” includes absolute perpendicularity and approximate perpendicularity, and an acceptable range of deviation of the approximate perpendicularity may also be a deviation within 5°; and the term “equal” includes absolute equality and approximate equality, and an acceptable range of deviation of the approximate equality may be a difference between two equals being less than or equal to 5% of either of the two equals.

It will be understood that when a layer or element is referred to as being on another layer or substrate, the layer or element may be directly on the another layer or substrate, or there may be intermediate layer(s) between the layer or element and the another layer or substrate.

Exemplary embodiments are described herein with reference to sectional views and/or plan views as idealized exemplary drawings. In the accompanying drawings, thicknesses of layers and sizes of areas are enlarged for clarity. Variations in shapes relative to the accompanying drawings due to, for example, manufacturing technologies and/or tolerances may be envisaged. Therefore, the exemplary embodiments should not be construed to be limited to the shapes of areas shown herein, but to include deviations in the shapes due to, for example, manufacturing. For example, an etched area shown in a rectangular shape generally has a feature of being curved. Therefore, the areas shown in the accompanying drawings are schematic in nature, and their shapes are not intended to show actual shapes of the areas in an apparatus, and are not intended to limit the scope of the exemplary embodiments.

Some embodiments of the present disclosure provide a display device XZ.

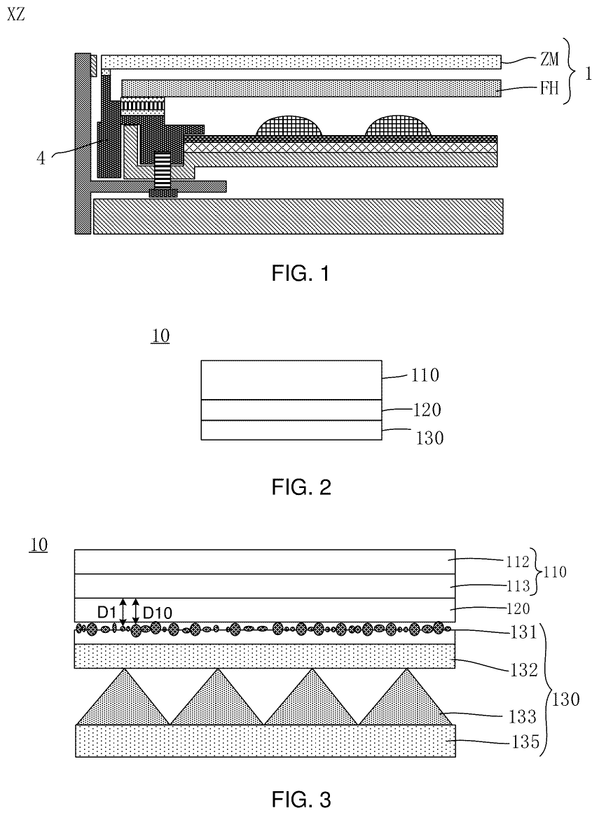

Referring to FIG. 1, the display device XZ is a product having a function of displaying images (including images in stationary or images in motion, where the images in motion may be a video). For example, the display device XZ may be a virtual reality (VR) display device, an augmented reality (AR) display device, a display, a mobile phone, a tablet computer (pad), a notebook computer, a television, a personal digital assistant (PDA), an ultra-mobile personal computer (UMPC), a netbook, a wearable device (such as smart watch) or a vehicle-mounted display device XZ. The embodiments do not limit the type of the display device XZ.

The display device XZ may include a display module 1. The display module 1 is configured to be a component for displaying a picture. For example, the display module 1 is configured to receive image data and display a picture corresponding to the image data.

In some examples, the display device XZ may further include a controller and the like. The controller is configured to send the image data (e.g., grayscale data) to the display module 1. The display module 1 receives the image data and displays the picture corresponding to the image data. For example, the controller may be a central processing unit (CPU) or a graphics processing unit (GPU).

The display device XZ further includes a frame 4 (such as a middle frame), and the frame 4 is configured to fix the display module 1, the controller and the like.

The display module 1 may include a display panel ZM. The display panel ZM is configured to receive data signals (e.g., voltage signals) corresponding to the image data, and to display an image (i.e., a picture) based on the data signals. The display panel ZM may have a display area and a non-display area (e.g., a display area and a non-display area of a first display panel below, or a display area and a non-display area of a second display panel below). The display area of the display panel ZM is an area of the display panel ZM that is capable of displaying an image, and an area of the display panel ZM other than the display area is the non-display area. The non-display area may be located on at least one side (e.g., one side or multiple sides) of the display area. For example, the non-display area is disposed around the display area.

In some examples, according to different display principles, the display panel ZM may be any of self-luminous display panels such as an organic light-emitting diode (OLED) display panel, a quantum dot light-emitting diode (QLED) display panel and a tiny light-emitting diode (a micro-LED or a mini-LED) display panel, or may be a liquid crystal display (LCD) panel.

For example, the display panel ZM includes a plurality of sub-pixels located in the display area. The display panel ZM further includes a plurality of signal lines such as a plurality of gate lines and a plurality of data lines. Each sub-pixel may be coupled to a gate line and a data line, and is configured to write a data signal transmitted by the data line in response to a scan signal transmitted by the gate line, and emit light with corresponding intensity based on the data signal.

In some examples, the plurality of gate lines may extend substantially in a first direction. In some examples, a gate line may be parallel to the first direction. As another example, there may be a small included angle between an extending direction of a gate line and the first direction. For example, the small included angle is in a range of −8° to 8° or in a range of −5° to 5°. The small included angle described below may refer to the above value range of the included angle, and adaptive selection may be made within the value range. A (e.g., each) gate line may be coupled to sub-pixels in the same row and configured to transmit a scan signal to the sub-pixels in the row. For example, the gate lines are located in the display area and may also extend into the non-display area.

In a possible implementation, the display panel ZM may further include gate driver circuit(s) located in the non-display area. In this case, the gate driver circuit may be called a GOA (gate on array) circuit. The gate driver circuit is coupled to a plurality of gate lines and configured to provide scan signals to the gate lines. For example, the gate driver circuit may be disposed on a side (e.g., a left side or a right side) of the display area in the first direction. In some other examples, the gate driver circuit may be a gate driver chip that is not included in the display panel ZM but is coupled to the plurality of gate lines in the display panel ZM.

In some examples, the plurality of data lines may extend substantially in a second direction. The second direction is perpendicular to the first direction. For example, a data line may be parallel to the second direction. In some examples, there may be a small included angle between a data line and the second direction. A (e.g., each) data line may be coupled to sub-pixels in the same column and configured to transmit a data signal to the sub-pixels in the column. For example, the data lines are located in the display area and may also extend into the non-display area.

In a possible implementation, the display panel ZM may further include a driver chip, which may be a driver integrated circuit (IC) such as a source driver IC or a display driver integrated circuit (DDIC). The driver chip is coupled to the display panel ZM, for example, may be bonded to the non-display area of the display panel ZM. The driver chip is configured to provide corresponding data signals to the display panel ZM based on the received image data. In some examples, the driver chip is coupled to a plurality of data lines and configured to provide data signals to the data lines.

For convenience of description, the first direction may be an extending direction of a long side of the display panel, and the second direction may be an extending direction of a wide side of the display panel. The first direction intersects the second direction, for example, the first direction and the second direction are perpendicular to establish a rectangular coordinate system.

In some examples, the display device XZ may further include a driver chip, which may be a driver integrated circuit (IC) such as a source driver IC or a display driver integrated circuit (DDIC). The driver chip is coupled to the display panel ZM, for example, may be bonded to the non-display area of the display panel ZM. The driver chip is configured to provide corresponding data signals to the display panel ZM based on the received image data.

In the related art, with continued reference to FIG. 1, the display module 1 further includes a composite prism film FH. For example, a display assembly in Example 1 hereinafter or second display panel in Example 2 hereinafter is fixed to the frame 4, and the composite prism film FH (e.g., a first composite prism film or a second composite prism film in the following context) is fixed to the frame 4. There is an air layer between the second display panel or display assembly and the composite prism film, and thus light will be reflected when passing through upper and lower surfaces of the air layer, resulting in a poor display effect of the display module 1.

Some embodiments of the present disclosure provide a display module to solve the problem of an air layer existing between the second display panel or display assembly and the composite prism sheet. The embodiments of the present disclosure provide two display modules. In order to make a distinction, the two display modules may be referred to as a first display module and a second display module. The first display module and the second display module are introduced below through two examples.

Example 1: referring to FIGS. 2 to 11, a first display module 10 is provided.

Referring to FIGS. 2 and 3, the first display module 10 may include a display assembly 110.

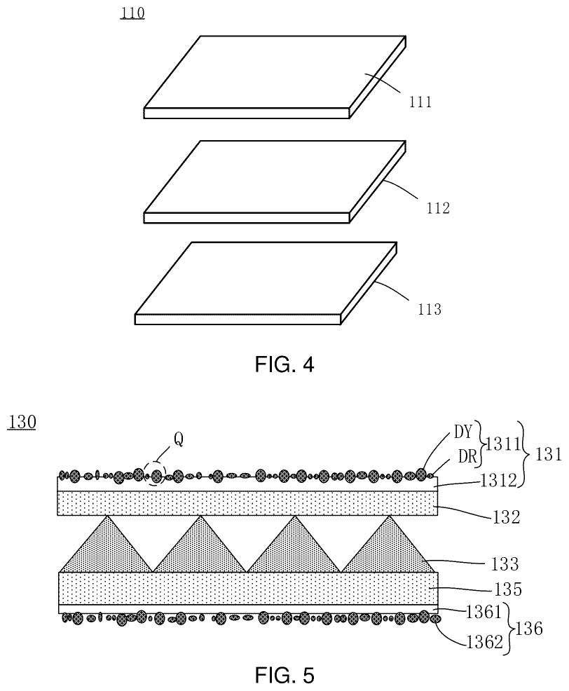

Referring to FIG. 4, the display assembly 110 includes a first display panel 112 and a first polarizer 113. The first polarizer 113 is disposed on a non-display surface of the first display panel 112. For example, the first polarizer 113 is attached to the non-display surface of the first display panel 112 (e.g., a liquid crystal display panel). The description of the first display panel 112 may refer to the related description of the display panel in the display device.

In some embodiments, referring to FIG. 4, the display assembly 110 further includes a second polarizer 111, and the second polarizer 111 is disposed on a display surface of the first display panel 112 (e.g., a liquid crystal display panel). For example, the second polarizer 111 is attached to the display surface of the first display panel 112 (e.g., the liquid crystal display panel). A polarization direction of the first polarizer 113 is perpendicular to a polarization direction of the second polarizer 111.

With continued reference to FIGS. 2 and 3, the first display module 10 further includes a first adhesive layer 120 and a first composite prism film 130. The first adhesive layer 120 bonds the first polarizer 113 in the display assembly 110 to the first composite prism film 130.

A haze of the first adhesive layer 120 may be less than 1%, and a light transmittance of the first adhesive layer 120 may be greater than 90% (such as 90%, 92%, 94%, 96%, 99% or 100%). The first adhesive layer 120 may be a highly transparent adhesive with a relatively low haze. For example, the first adhesive layer 120 may be an optically clear adhesive (OCA). Young's modulus of the first adhesive layer 120 is greater than 270 KPa, which reduces an internal stress generated between the first adhesive layer 120 and the first composite prism film 130. A thickness of the first adhesive layer 120 is in a range of 50 μm to 125 μm, inclusive. In a case where the first adhesive layer 120 is relatively thick, the cost is relatively high; and in a case where the first adhesive layer 120 is relatively thin, the adhesive ability is relatively weak.

With continued reference to FIGS. 2 and 3, the first composite prism film 130 includes a haze layer 131 and a first prism layer 133.

The haze layer 131 may be an optical film with a certain haze. The first prism layer 133 is disposed on a side of the first polarizer 113 away from the first display panel 112. The haze layer 131 is disposed on the first prism layer 133 and is located between the first prism layer 133 and the first polarizer 113. That is, the first display panel 112, the first polarizer 113, the first adhesive layer 120 and the first composite prism film 130 are stacked in sequence. The first adhesive layer 120 bonds the haze layer 131 in the first composite prism film 130 to the first polarizer 113 in the display assembly 110.

In some examples, the first composite prism film 130 further includes a first base material layer 135. The material of the first base material layer may be thermoplastic polyester, such as polyethylene terephthalate (PET). The first prism layer 133 is disposed on the first base material layer 135. The haze layer 131 is disposed on a side of the first prism layer 133 away from the first base material layer 135.

An orthographic projection of the first adhesive layer 120 on a plane where the first display panel 112 is located covers at least a display area of the first display panel 112. In some examples, the orthographic projection of the first adhesive layer 120 on the plane where the first display panel 112 is located covers the display area of the first display panel 112. In some other examples, the orthographic projection of the first adhesive layer 120 on the plane where the first display panel 112 is located covers both the display area and a non-display area of the first display panel 112.

In this way, the first adhesive layer 120 is used to bond the haze layer 131 in the first composite prism film 130 to the first polarizer 113 in the display assembly 110, so that the display assembly 110 and the first composite prism film 130 form a full-attachment first display module 10. In this way, in the full-attachment first display module 10, there is no gap between the first polarizer 113 and the first composite prism film 130 (i.e., the air layer in the related art is removed). As a result, there is no more specular reflected light inside the first display module 10, so that the first display module 10 has a clear display picture. In addition, the thickness of the first display module 10 may also be reduced, thereby causing the first display module 10 to develop towards ultra-thinness and ultra-lightness.

When incident light (e.g., the light exiting from a backlight layer in the display device described below) passes through the first prism layer 133, part of the incident light with an incident angle less than a preset angle may be refracted out by the first prism layer 133, and the remaining of the incident light is reflected back to the backlight layer by the first prism layer 133 due to not meeting the refraction condition of the first prism layer 133, and is reflected by a reflective sheet at the bottom of the backlight layer and is incident into the first prism layer 133 again. In this way, the incident light exiting from the backlight layer is continuously recycled under the action of the first prism layer 133, thereby achieving a brightness enhancement effect.

When the light enters the haze layer 131 through the first prism layer 133, since the haze layer 131 has haze, for example, the haze of the haze layer 131 is greater than or equal to 70% (e.g., the haze of the haze layer 131 may be 70%, 72%, 74%, 76%, 78%, 80%, 82%, 84%, 86%, 88%, 90%, 92%, 94%, 96%, 98%, 99% or 100%), the light is scattered by the haze layer 131, thereby improving the luminance of the first display panel 112.

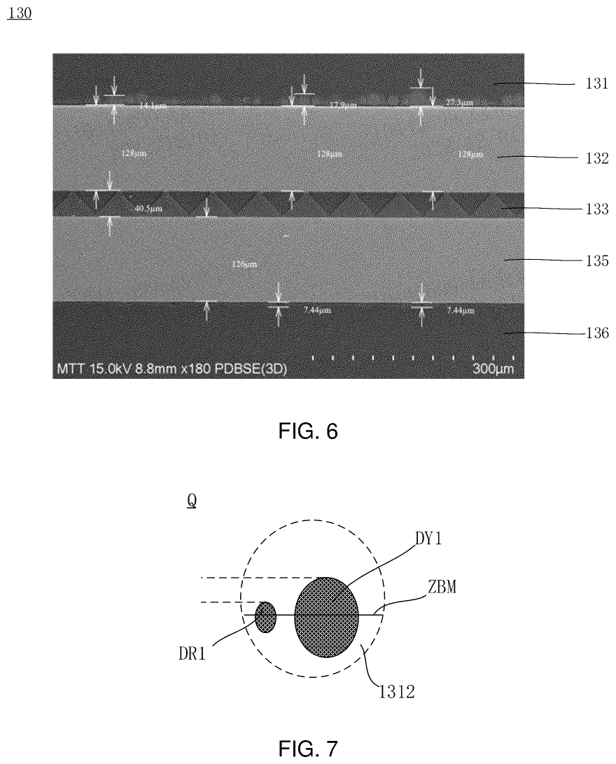

Referring to FIGS. 5 and 6, the haze layer 131 includes a first bonding agent layer 1312 and a plurality of first diffusion particles 1311. The plurality of first diffusion particles 1311 are dispersed in the first bonding agent layer 1312. In this way, the provision of the plurality of first diffusion particles 1311 may play a role of refracting and scattering light. The material of the first bonding agent layer 1312 may be a resin with adhesive ability, such as acrylic resin.

In some embodiments, the plurality of first diffusion particles 1311 include a plurality of first particles DY, and hardness of the first particles DY is greater than or equal to 20 MPa. In this way, when the first adhesive layer 120 squeezes the first particles DY in the haze layer 131, the first particles DY will not deform due to the great hardness of the first particles DY. Thus, the first particles DY may be avoided to generate the internal stress, so that rainbow patterns are generated between the haze layer 131 and the first adhesive layer. The material of the first particles DY may be an organic material with relatively high hardness. For example, the organic material may be polyester resin, and the polyester resin may be polymethyl methacrylate (PMMA).

In some examples, for at least some of the plurality of first particles DY (e.g., the plurality of first particles DY, or part of the plurality of first particles DY), a portion of each first particle DY is embedded in the first bonding agent layer 1312, and the other portion of each first particle DY protrudes from the first bonding agent layer 1312 and is bonded to the first adhesive layer 120. For a case that portions of first particles DY may be embedded in the first bonding agent layer 1312, the portions of the first particles DY have loss in light scattering.

For example, for all the first particles DY, a portion of each first particle DY is embedded in the first bonding agent layer 1312, and the other portion of each first particle DY protrudes from the first bonding agent layer 1312 and is bonded to the first adhesive layer 120.

In this way, a portion of the first particle DY exposed outside the first bonding agent layer 1312 may play a role of refracting and scattering light. Refracted light and scattered light exiting from the portion of the first particle DY exposed outside the first bonding agent layer 1312 may directly be transmitted to the first polarizer 113.

In some examples, particle sizes of the plurality of first particles DY may be the same or different. For example, the particle size of the first particle DY is in a range of 2 μm to 30 μm (e.g., 2 μm, 5 μm, 10 μm, 15 μm, 20 μm, 25 μm or 30 μm).

For example, with continued reference to FIGS. 5 and 6, the plurality of first diffusion particles further include a plurality of second particles DR. In some examples, hardness of the plurality of second particles DR is less than 20 MPa. The material of the second particle DR may be from some organic materials with relatively low hardness. For example, the material of the second particle DR may be polyester resin, and the polyester resin may be poly(n-butyl methacrylate) (PBMA).

The plurality of second particles DR are dispersed in the first bonding agent layer 1312. In this way, both the first particles DY and the second particles DR may play the role of refracting light and scattering light. The hardness of the first particle DY is greater than the hardness of the second particle DR. A total mass of the plurality of first particles DY is greater than a total mass of the plurality of second particles DR. For example, a density of the first particles DY is greater than or equal to a density of the second particles, and a total volume of the plurality of first particles DY is greater than a total volume of the plurality of second particles DR. In this way, the first particles DY may play a supporting role, thereby reducing the squeeze of the first adhesive layer 120 on the second particles DR and the first bonding agent layer 1312. Therefore, the second particles DR may play a role of refracting and scattering light instead of supporting effect. Furthermore, with the cooperation of the first particles DY and the second particles DR, the haze layer 131 has a good supporting effect as well as a good light refraction and scattering effect.

For example, an average particle size of the plurality of first particles DY is greater than an average particle size of the plurality of second particles DR. As a result, the first particle DY may have a good supporting effect. In some examples, particle sizes of the plurality of second particles DR may be the same or different. For example, the particle size of the second particle DR is in a range of 2 μm to 10 μm (e.g., 2 μm, 3 μm, 4 μm, 5 μm, 6 μm, 7 μm, 8 μm, 9 μm or 10 μm).

For example, a ratio of the total mass of the plurality of first particles DY to a mass of the first bonding agent layer 1312 is greater than or equal to 60%. In some examples, a ratio of the total mass of the plurality of second particles DR to the total mass of the first bonding agent layer 1312 is less than or equal to 40%. In this way, the plurality of first particles DY may play a supporting role.

| | | | | | | A total mass |
|---|---|---|---|---|---|---|
| | | | | | A total mass | ratio of |
| | | Average | | Average | ratio of first | second |
| | Particle size | particle size | Particle size | particle size | particles to | particles to |
| | of first | of first | of second | of second | first bonding | first bonding |
| | particle | particles | particle | particles | agent layer | agent layer |
| First | 7~30 μm | 15 μm | 3~6 μm | 4 μm | 81% | 26% |
| example | | | | | | |
| Second | 7~23 μm | 15 μm | 3~6 μm | 4 μm | 76% | 12% |
| example | | | | | | |

### Table 1 is a Ratio Table of the Haze Layer

It can be seen from Table 1 that the haze of the haze layer is in a range of 89% to 95%.

For example, referring to FIGS. 5 and 7, the haze layer 131 has a sampling area Q, and an orthographic projection of the sampling area on the first display panel 112 is located within the display area of the first display panel 112. A unit length of the sampling area is at least greater than or equal to 150 μm (e.g., 150 μm, 200 μm, 250 μm, 300 μm, 350 μm, 400 μm, 450 μm, 500 μm, 550 μm or 600 μm). A unit length of the display area of the first display panel 112 is greater than or equal to the unit length of the sampling area. The unit length may be understood as a length of a side of a square, for example, in a case where the unit length of the sampling area is 150 μm, the sampling area may be expressed as a square of 150 μm by 150 μm.

In the sampling area, as shown in FIG. 3, a distance D10 between the lowest first particle DY1 and the first polarizer 113 is smaller than a distance D1 between the second particles and the first polarizer 113. In this way, the distance D1 allows the first adhesive layer 120 to be in contact with the first particles DY but not to be in contact with both the second particles DR and the first bonding agent layer 1312. That is, the first particles DY play a supporting role, so that the squeeze of the first adhesive layer 120 on the second particles DR and the first bonding agent layer 1312 may be eliminated, thereby avoiding internal stress generated in the second particles DR caused by deformation of the second particles DR.

The lowest first particle DY1 is a first particle DY farthest from the first polarizer 113 among all the first particles DY protruding from an upper surface of the first bonding agent layer 1312. It can be understood that, as shown in FIG. 7, the lowest first particle DY1 is the first particle DY closest to the upper surface ZBM of the first bonding agent layer 1312 among all the first particles DY protruding from the upper surface ZBM of the first bonding agent layer 1312. The upper surface ZBM of the first bonding agent layer 1312 may be a surface of the first bonding agent layer 1312 closest to the first polarizer 113.

In some examples, in the sampling area, the distance between the lowest first particle DY1 and the first polarizer 113 is smaller than the distance D1 between the highest second particle DR1 and the first polarizer 113. In this way, the distance D1 allows the first adhesive layer 120 to be in contact with the first particles DY but not to be in contact with both the second particles DR and the first bonding agent layer 1312. In addition, a portion of the highest second particle DR1 protruding from the upper surface ZBM of the first bonding agent layer 1312 may improve the scattering and refraction of light. For example, the distance D1 is in a range of 3.5 μm to 10 μm (e.g., 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm or 10 μm).

The highest second particle DR1 is a second particle DR closest to the first polarizer 113 among all the second particles DR protruding from the upper surface ZBM of the first bonding agent layer 1312. It can be understood that the highest second particle DR1 is a second particle DR farthest from the upper surface ZBM of the first bonding agent layer 1312 among all the second particles DR protruding from the upper surface ZBM of the first bonding agent layer 1312.

In some examples, in the sampling area, the distance between the lowest first particle DY and the first polarizer 113 is smaller than the distance between the second particles located in the first bonding agent layer 1312 and the first polarizer 113.

For example, at least a portion of the second particle DR is embedded in the first bonding agent layer 1312. For example, a portion of the second particle DR is embedded in the first bonding agent layer 1312, and the other portion of the second particle DR is exposed outside the first bonding agent layer 1312. In this way, the portion of the second particle DR exposed outside the first bonding agent layer 1312 may refract and scatter light. Specifically, refracted light and scattered light exiting from the portion of the second particle DR exposed outside the first bonding agent layer 1312 may directly be transmitted to the first polarizer 113, so as to avoid attenuation of light flux caused by being reflected by the upper surface and lower surface of the first bonding agent layer 1312, thereby increasing the refractive ability of the haze layer 131. As another example, the second particles DR are embedded in the first bonding agent layer 1312.

In some embodiments, lights exiting from the regularly arranged backlight layer enter the first prism layer 133 (including a plurality of first prism units that are regularly distributed) without scattering, and light interference may occur between the lights. Therefore, with continued reference to FIGS. 5 and 6, the first composite prism film 130 further includes a first back coating layer 136. The first back coating layer 136 is disposed on a side of the first prism layer 133 away from the first display panel 112. In this way, the first back coating layer 136 may reduce or eliminate the interference light between the backlight layer and the first prism layer 133. In some examples, the first base material layer 135 is disposed on a side of the first prism layer 133 away from the first polarizer 113, and the first back coating layer 136 is disposed on a side of the first base material layer 135 away from the first prism layer 133.

The first back coating layer 136 includes a second bonding agent layer 1361 and a plurality of second diffusion particles 1362 dispersed in the second bonding agent layer 1361. The light exiting from the regularly arranged backlight layer passes through the second diffusion particles 1362 to form scattered light. Since the propagation law of the scattered light is different from the arrangement law of the first prism layer 133, the interference light between the backlight layer and the first prism layer 133 is reduced. In some examples, the second bonding agent layer 1361 is disposed on a side of the first base material layer 135 away from the first prism layer 133.

For example, with continued reference to FIG. 5, in a case where the display device uses a diffusion plate, a haze of the first back coating layer 136 is in a range of 35% to 70% (e.g., 35%, 40%, 45%, 50%, 55%, 60%, 65% or 70%). By utilizing dual effects of the haze of the first back coating layer 136 and the diffusion plate, the interference light between the backlight layer and the first prism layer 133 may be eliminated, so as to achieve light homogenization and scattering effect, thereby playing a role of atomization and shielding.

In a case where the haze of the first back coating layer 136 is in the range of 35% to 70%, the material of the second diffusion particles 1362 may be an organic material such as polyester resin, and the polyester resin may be polymethyl methacrylate (PMMA). The particle size of the second diffusion particle 1362 is in a range of 5 μm to 10 μm (e.g., 5 μm, 6 μm, 7 μm, 8 μm, 9 μm or 10 μm).

As another example, in a case where the display device does not use a diffusion plate, light may produce horizontal diamond patterns in the first prism layer 133. Moreover, when the light passes through the prism film of the display device, a network-like diamond pattern may also be generated between the first prism layer 133 and the prism film. The haze of the first back coating layer 136 is greater than or equal to 90% (e.g., 90%, 92%, 94%, 96%, 98% or 100%). In this way, the haze of the first back coating layer 136 increases, thus the ability of light homogenization and scattering may be improved, and further the ability of the first back coating layer 136 interfering with light interference may be enhanced, thereby improving the atomization and shielding effect of the first back coating layer 136.

In a case where the haze of the first back coating layer 136 is greater than or equal to 90%, the second diffusion particles 1362 include a plurality of sixth particles and fifth particles. The material of the sixth particles is an organic substance, such as polyester resin. The material of the fifth particles may be a metal oxide, such as titanium oxide. The particle size of the second diffusion particle 1362 is less than or equal to 4 μm (e.g., 0.1 μm, 0.5 μm, 1 μm, 1.5 μm, 2 μm, 2.5 μm, 3 μm, 3.5 μm or 4 μm). A ratio of a total mass of the plurality of fifth particles to a total mass of the plurality of sixth particles is in a range of 40% to 60% (e.g., 40%, 43%, 45%, 47%, 50%, 53%, 57% or 60%).

In some examples, a portion of the second diffusion particle 1362 is embedded in the second bonding agent layer 1361, and the other portion of the second diffusion particle 1362 protrudes from the second bonding agent layer 1361.

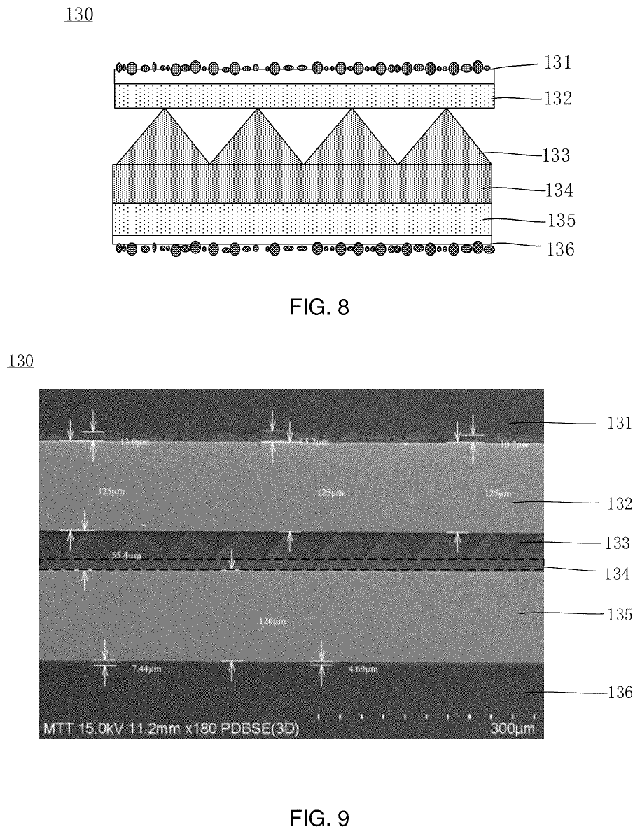

In some embodiments, with reference to FIGS. 8 and 9, the first composite prism film 130 further includes a first brightness enhancement layer 134. The first brightness enhancement layer 134 is disposed between the first base material layer 135 and the first prism layer 133. The refractive index of the first brightness enhancement layer 134 is smaller than the refractive index of the first base material layer 135. In this way, the light enters the first prism layer 133 through the first base material layer 135 and the first brightness enhancement layer 134, the added first brightness enhancement layer 134 may increase the incident angle and optical path of the light entering the first prism layer 133, thereby improving the display uniformity of the first display panel 112.

In some examples, the refractive index of the first brightness enhancement layer 134 is in a range of 1.49 to 1.51 (e.g., 1.49, 1.50 or 1.51). The material of the first base material layer 135 may be an organic material, such as an optical resin. Therefore, the refractive index of the first base material layer 135 is 1.62. In a stacking direction of the first base material layer 135, the first brightness enhancement layer 134 and the first prism layer 133 (i.e., in a thickness direction of the display module), a thickness of the first brightness enhancement layer 134 is in a range of 15 μm to 50 μm (e.g., 15 μm, 20 μm, 25 μm, 30 μm, 35 μm, 40 μm, 45 μm or 50 μm).

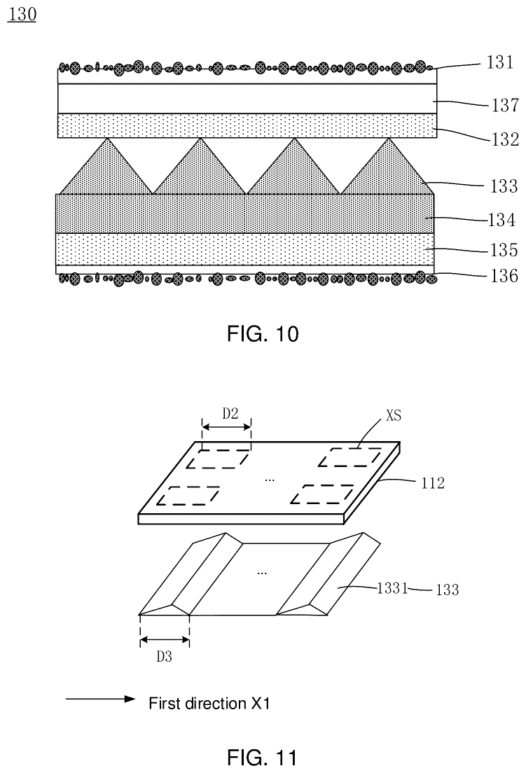

In some embodiments, with continued reference to FIG. 10, the first composite prism film 130 further includes a polarizing brightness enhancement layer 137. The polarizing light enhancement layer 137 is provided between the first prism layer 133 and the haze layer 131. In some examples, the first composite prism film further includes a second base material layer 132, and the second base material layer 132 is disposed between the polarizing brightness enhancement layer 137 and the first prism layer 133. For example, the polarizing brightness enhancement layer 137 may be attached to the second base material layer 132. The description of the material of the second base material layer 132 may refer to the related description of the material of the first base material layer 135.

In some embodiments, referring to FIG. 11, the first display panel 112 includes a plurality of sub-pixels XS located in the display area. The plurality of sub-pixels XS include a first sub-pixel for emitting light of first color, a second sub-pixel for emitting light of second color and a third sub-pixel for emitting light of third color. The first color, the second color, and the third color are three primary colors (e.g., red, green and blue). The first display panel 112 may include red sub-pixels, green sub-pixels and blue sub-pixels.

The plurality of sub-pixels XS are arranged in a plurality of columns. The first direction is an extending direction of a long side of the first display panel 112. It can be understood that the first direction is perpendicular to an arrangement direction of sub-pixels in the plurality of columns and parallel to the plane where the first display panel 112 is located.

The first prism layer 133 includes a plurality of first prism units 1331. In some examples, the first prism unit 1331 is in a shape of a triangular prism. For example, the first prism unit 1331 may be a triangular prism with a vertex angle of 90°.

In the first direction, a ratio of a dimension D3 of the first prism unit 1331 to a dimension D2 of the sub-pixel XS is equal to n, and n is a positive number except for 0.5 and positive integers (e.g., n is a value of 0 to 0.5, 0.5 to 1, 1 to 2, 2 to 3, and the like). In this way, it may avoid generation of interference light between the plurality of sub-pixels XS and the plurality of first prism units 1331.

For example, in the first direction, the ratio of the dimension D3 of the first prism unit 1331 to the dimension D2 of the sub-pixel XS may be in a range of 0.1 to 0.49 (e.g., 0.1, 0.2, 0.3, 0.4, 0.43, 0.45, 0.47 or 0.49). As another example, in the first direction, the ratio of the dimension D3 of the first prism unit 1331 to the dimension D2 of the sub-pixel XS may be in a range of 0.51 to 0.99 (e.g., 0.51, 0.53, 0.57, 0.6, 0.63, 0.67, 0.7, 0.8, 0.9 or 0.99).

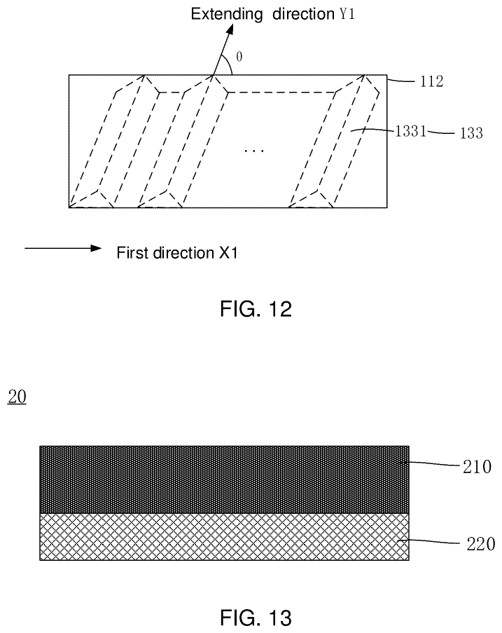

Referring to FIG. 12, the first prism layer 133 includes a plurality of columns of first prism units 1331. An included angle θ between an extending direction of the first prism unit 1331 and an extending direction of the long side of the first display panel 112 is greater than or equal to 30° and less than or equal to 150° (e.g., 30°, 40°, 50°, 60°, 70°, 80°, 90°, 100°, 110°, 120°, 130°, 140° or) 150°. In this way, the included angle θ is beneficial to improving diagonal patterns, thereby avoiding moiré patterns generated between the first polarizer 113 and the first composite prism film 130. The included angle θ greater than or equal to 90° is beneficial to improving the viewing angle.

Embodiments of the present disclosure further provide a method of assembling the first display module. The assembling method includes the following steps.

In step 1, the first composite prism film is manufactured, which may include steps S110 to S170.

In step S110, the first base material layer is formed. In step S120, the first brightness enhancement layer is formed on the first base material layer. In step S130, the first prism layer is formed on a side of the first brightness enhancement layer away from the first base material layer. In step S140, the first back coating layer is formed on a side of the first base material layer away from the first brightness enhancement layer. In step S150, the second base material layer is formed on a side of the first prism layer away from the first base material layer. In step S160, the polarizing brightness enhancement layer is formed on a side of the second base material layer away from the first base material layer. In step S170, the haze layer is formed on a side of the polarizing brightness enhancement layer away from the first base material layer. In some examples, the step S150, the step S160 and the step S170 are executed first, and then the step S130 and the step S140 are executed.

In step 2, the display assembly is manufactured, which may include the following step.

The first polarizer is formed on a non-display surface of the first display panel. For example, the first polarizer is attached to the non-display surface of the first display panel.

In step 3, the first adhesive layer is used to bond the first composite prism film to the first polarizer in the display assembly.

Example 2: referring to FIGS. 13 to 20, a second display module 20 is provided.

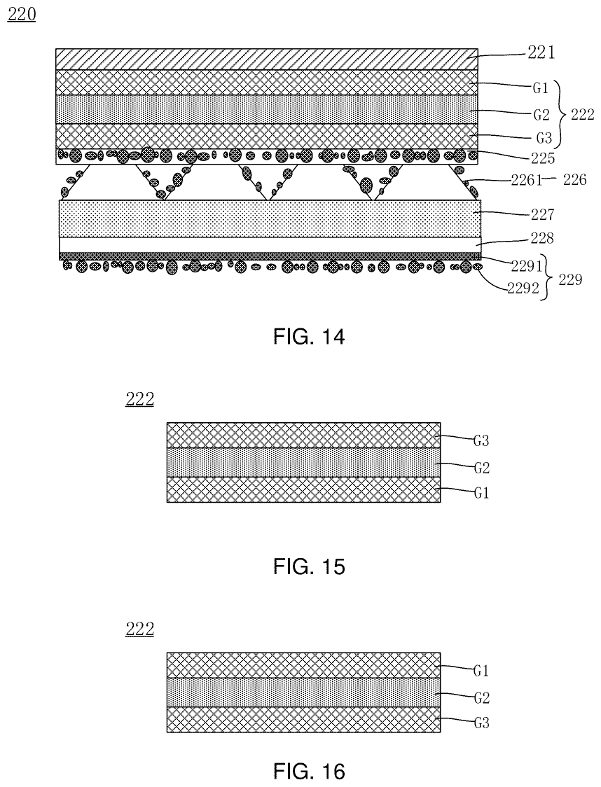

Referring to FIGS. 13 and 14, the second display module 20 includes a second display panel 210 and a second composite prism film 220. The second composite prism film 220 is attached to a non-display surface of the second display panel 210. For related descriptions of the second display panel 210, reference may be made to the related description of the display panel in the display device. In some examples, the first display panel in Example 1 and the second display panel 210 in Example 2 may be the same (e.g., both may be liquid crystal display panels) or different.

The second composite prism film 220 includes a second adhesive layer 221, a third adhesive layer 225, a second prism layer 226 and a polarizing unit 222. The polarizing unit 222 is disposed on a side of the non-display surface of the second display panel 210. The second adhesive layer 221 bonds the second display panel 210 to the polarizing unit 222. The third adhesive layer 225 bonds the second prism layer 226 to the polarizing unit 222. That is, the second display panel 210, the second adhesive layer 221, the polarizing unit 222, the third adhesive layer 225 and the second prism layer 226 are stacked in sequence.

The polarizing unit 222 includes a polarizing layer G2 and a first support layer G1 that are stacked. In some examples, the second adhesive layer 221 bonds the first support layer G1 to the second display panel 210, and the polarizing layer G2 is disposed on a side of the first support layer G1 away from the second display panel 210. That is, the second prism layer 226, the third adhesive layer 225, the polarizing layer G2, the first support layer G1 and the second display panel 210 are stacked in sequence. In some other examples, the second adhesive layer 221 bonds the polarizing layer G2 to the second display panel 210, and the first support layer G1 is disposed on a side of the polarizing layer G2 away from the second display panel 210. That is, the second prism layer 226, the third adhesive layer 225, the first support layer G1, the polarizing layer G2 and the second display panel 210 are stacked in sequence.

An orthographic projection of the second adhesive layer 221 on a plane where the second display panel 210 is located covers at least the display area. In some examples, the orthographic projection of the second adhesive layer 221 on the plane where the second display panel 210 is located covers the display area. In some other examples, the orthographic projection of the second adhesive layer 221 on the plane where the second display panel 210 is located covers both the display area and the non-display area.

In this way, the second adhesive layer 221 in the second composite prism film 220 is used to make the second display panel 210 and the second composite prism film 220 fully attached. Therefore, there is no gap between the second display panel 210 and the second composite prism film (i.e., the air layer between the second display panel 210 and the second composite prism film is removed). In this way, there is no more specular reflected light inside the second display module 20, so that the second display module 20 has a clear display picture. In addition, the thickness of the second display module 20 may also be reduced, thereby causing the display module to develop towards ultra-thinness and ultra-lightness.

In some examples, the second display module 20 further includes an upper polarizer, and the upper polarizer is disposed on a display surface (i.e., a light exit surface) of the second display panel 210 (e.g., the liquid crystal display panel). For example, the upper polarizer is attached to the display surface of the second display panel 210 (e.g., the liquid crystal display panel). The polarization direction of the upper polarizer is perpendicular to the polarization direction of the polarizing layer G2.

The second prism layer 226 has a plurality of first light exit surfaces 2261, and the first light exit surfaces 2261 are inclined relative to the plane where the second display panel 210 is located. The first light exit surface 2261 is an uneven surface, so that the first light exit surface 2261 in the second prism layer 226 has a certain haze, and thus it may avoid increase of the thickness of the second prism layer 226.

Haze treatment is performed on one of the second adhesive layer 221, the first support layer G1 and the third adhesive layer 225. For example, haze treatment is performed on the second adhesive layer 221. As another example, haze treatment is performed on the first support layer G1. As another example, haze treatment is performed on the third adhesive layer 225.

The embodiments of present disclosure further provide a first comparison solution. The first comparison solution includes the second prism layer 226, the third adhesive layer 225, the polarization unit (the first support layer G1 and the polarizing layer G2), the second adhesive layer 221 and the second display panel 210 that are stacked in sequence, and one of the first light exit surfaces 2261, the second adhesive layer 221, the first support layer G1 and the third adhesive layer 225 is subjected to haze treatment.

In order to solve the rainbow patterns between the second display panel 210 and the second composite prism film 220, the first comparison solution needs to increase haze of one of the first light exit surfaces 2261, the second adhesive layer 221, the first support layer G1 and the third adhesive layer 225. As a result, the thickness of one of the first light exit surfaces 2261, the second adhesive layer 221, the first support layer G1 and the third adhesive layer 225 increases. In addition, as the haze increases, the thickness will double. Moreover, the light transmittance decreases and the process difficulty will double. In this way, the display module in the first comparison solution has a relatively large thickness, which is not conducive to the development of the display module towards ultra-thinness and ultra-lightness. In addition, the increase of the haze of the second adhesive layer 221 and the third adhesive layer 225 causes the adhesion ability of the second adhesive layer 221 and the third adhesive layer 225 to decrease, thereby causing the display module to be prone to adhesive detachment. The yellowing of the display module is quite serious.

During the reliability test (e.g., high temperature test and high humidity test), since the reliability test conditions for the first comparison solution are the same as the reliability test conditions for the second display panel, the first comparison solution cannot pass the reliability test.

The embodiments of present disclosure further provide a second comparison solution. The second comparison solution includes the second prism layer 226, the third adhesive layer 225, the polarizing unit (the first support layer G1 and the polarizing layer G2), the second adhesive layer 221 and the second display panel 210 that are stacked in sequence, and at least two of the second adhesive layer 221, the first support layer G1 and the third adhesive layer 225 are subjected to haze treatment. In addition, the second adhesive layer 221 and the third adhesive layer 225 are both subjected to haze treatment, which causes the display module to be seriously yellow.

During the reliability test (e.g., high temperature test and high humidity test), since the reliability test conditions for the second comparison solution are the same as the reliability test conditions for the second display panel, the first comparison solution cannot pass the reliability test.

Compared with the first comparison solution and the second comparison solution, in the embodiments of the present disclosure, the haze of the first light exit surfaces 2261 and the haze of one of the second adhesive layer 221, the first support layer G1 and the third adhesive layer 225 are used to solve the rainbow patterns between the second display panel 210 and the second composite prism film 220. In addition, the haze of the first light exit surfaces 2261 is small, and the haze of one of the second adhesive layer 221, the first support layer G1 and the third adhesive layer 225 is small, so that the thicknesses thereof are thin, the process is simple, and the light transmittance is also good.

For example, the haze of one of the second adhesive layer 221, the first support layer G1 and the third adhesive layer 225 is in a range of 45% to 60% (e.g., 45%, 47%, 49%, 50%, 53%, 55%, 57% or 60%). For example, the haze of the second adhesive layer 221 is in a range of 45% to 60%. As another example, the haze of the first support layer G1 is in a range of 45% to 60%. As another example, the haze of the third adhesive layer 225 is in a range of 45% to 60%.

In some examples, in a case where the haze of one of the second adhesive layer 221, the first support layer G1 and the third adhesive layer 225 is in a range of 45% to 60%, and the hazes of the other two are both less than 1%. For example, in a case where the haze of the second adhesive layer 221 is in a range of 45% to 60%, the haze of the first support layer G1 and the haze of the third adhesive layer 225 are both less than 1%. In this case, the second adhesive layer 221 may be a haze adhesive, and the third adhesive layer 225 may be a resin adhesive. As another example, in a case where the haze of the first support layer G1 is in a range of 45% to 60%, the haze of the second adhesive layer 221 and the haze of the third adhesive layer 225 are both less than 1%. In this case, the second adhesive layer 221 may be a pressure sensitive adhesive, and the third adhesive layer 225 may be a resin adhesive. As another example, in a case where the haze of the third adhesive layer 225 is in a range of 45% to 60%, the haze of the second adhesive layer 221 and the haze of the first support layer G1 are both less than 1%. In this case, the second adhesive layer 221 may be a pressure sensitive adhesive, and the third adhesive layer 225 may be a haze adhesive.

In some examples, the polarizing unit 222 further includes a second support layer G3. For the related description of the material of the second support layer G3, reference may be made to the related description of the material of the first support layer G1.

The second support layer G3, the polarizing layer G2 and the first support layer G1 are stacked in sequence. The haze of the second support layer G3 is less than 1%. In some examples, referring to FIG. 15, from bottom to top, the first support layer G1, the polarizing layer G2 and the second support layer G3 are stacked in sequence. That is, in a case where the third adhesive layer 225 bonds the first support layer G1 and the second prism layer 226, the second adhesive layer 221 bonds the second support layer G3 and the second display panel 210. In some other examples, referring to FIG. 16, from bottom to top, the second support layer G3, the polarizing layer G2 and the first support layer G1 are stacked in sequence. That is, in a case where the third adhesive layer 225 bonds the second support layer G3 and the second prism layer 226, the second adhesive layer 221 bonds the first support layer G1 and the second display panel 210.

In some examples, the haze of the first light exit surfaces 2261 is in a range of 40% to 50% (e.g., 40%, 42%, 44%, 45%, 47%, 49% or 50%).

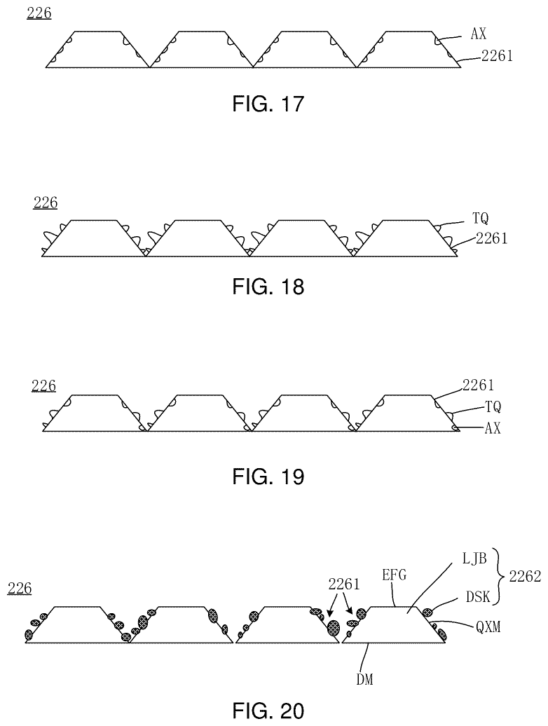

In some examples, referring to FIG. 17, the first light exit surface 2261 has a plurality of recessed portions AX. In some examples, referring to FIG. 18, the first light exit surface 2261 has a plurality of protrusion portions TQ. In some examples, referring to FIG. 19, the first light exit surface 2261 has a plurality of recessed portions AX and a plurality of protrusion portions TQ. A size of the recessed portion AX is less than or equal to 0.5 μm (e.g., 0.5 μm, 0.4 μm, 0.3 μm, 0.2 μm or 0.1 μm). A size of the protrusion portion TQ is less than or equal to 0.5 μm (e.g., 0.5 μm, 0.4 μm, 0.3 μm, 0.2 μm or 0.1 μm).

In some examples, referring to FIG. 20, the second prism layer 226 includes a plurality of second prism units 2262. The second prism unit 2262 includes a prism body LJB and a plurality of third diffusion particles DSK. The prism body LJB has a bottom surface DM and inclined surfaces QXM connected to the bottom surface DM. The plurality of third diffusion particles DSK are pasted on the inclined surfaces QXM of the prism body LJB to form the first light exit surface 2261 of the second prism unit 2262.

In some examples, a particle size of the third diffusion particle DSK is less than or equal to 0.5 μm (e.g., 0.5 μm, 0.4 μm, 0.3 μm, 0.2 μm or 0.1 μm).

In some examples, the plurality of third diffusion particles DSK include a plurality of third particles and a plurality of fourth particles. The material of the third particles is an organic material, such as polyester resin. The material of the fourth particles may be metal oxide, such as titanium oxide. Among the plurality of third diffusion particles DSK, a ratio of a total mass of the plurality of fourth particles to a total mass of the plurality of third particles is in a range of 30% to 50% (e.g., 30%, 34%, 35%, 37%, 39%, 40%, 44%, 46%, 49% or 50%).

In some examples, the second prism layer 226 includes a plurality of second prism units 2262. The second prism unit 2262 has a second light exit surface EFG and two first light exit surfaces 2261, and the second light exit surface EFG is connected with the two first light exit surfaces 2261. The second light exit surface EFG is parallel to the plane where the second display panel 210 is located. The second light exit surface EFG is bonded to the third adhesive layer 225. In this way, the cross section of the second prism unit is trapezoidal.

In some examples, referring to FIG. 14, the second composite prism film 220 further includes a third base material layer 228 and a second brightness enhancement layer 227. The third base material layer 228 is disposed on a side of the second prism layer 226 away from the polarizing unit 222. The second brightness enhancement layer 227 is disposed between the third base material layer 228 and the second prism layer 226 and is in contact with the third base material layer 228. The refractive index of the second brightness enhancement layer 227 is smaller than the refractive index of the third base material layer 228. For the effect of the second brightness enhancement layer 227 and the third base material layer 228, reference may be made to the effect brought by the first brightness enhancement layer and the first base material layer, and details are not repeated.

In some examples, the second composite prism film 220 further includes a release film. The release film is located on a side of the second adhesive layer 221 away from the polarizing unit 222 and is detachably disposed on the second adhesive layer 221. When the second composite prism film 220 is attached to the second display panel, the release film is first peeled off, and then the second adhesive layer 221 of the second composite prism film 220 is used to bond to the second display panel. In this way, the release film may make the second adhesive layer 221 have good adhesion.

In some embodiments, with continued reference to FIG. 14, the second composite prism film 220 further includes a second back coating layer 229. The second back coating layer is disposed on a side of the second prism layer 226 away from the second display panel 210. The second back coating layer 229 includes a third bonding agent layer 2291 and a plurality of fourth diffusion particles 2292 dispersed in the third bonding agent layer 2291. The haze of the second back coating layer 229 is greater than or equal to 90%. Alternatively, the haze of the second back coating layer 229 is in a range of 35% to 70%. In a case where the haze of the second back coating layer 229 is in the range of 35% to 70%, the material of the fourth diffusion particles 2292 is an organic material, such as polyester resin, and the particle size of the fourth diffusion particle 2292 is in a range of 5 μm to 10 μm. In a case where the haze of the second back coating layer 229 is greater than or equal to 90%, the fourth diffusion particles 2292 include eighth particles and seventh particles. The material of the eighth particles is an organic substance, and the material of the seventh particles may be a metal oxide, such as titanium oxide. The particle size of the fourth diffusion particle 2292 is less than or equal to 4 μm. For descriptions of the components, material and effect of the second back coating layer 229, reference may be made to the related descriptions of the components, material and effect of the first back coating layer, and details are not repeated.

Embodiments of the present disclosure provide a method of assembling the second display module. The assembling method includes the following steps.

In step 4, the second composite prism film is manufactured, which may include steps S210 to S230.

In step S210, the second prism layer is formed on the third base material layer. In step S220, the third adhesive layer is used to bond the polarizing unit to the second prism layer, and the polarizing unit is located on a side of the second prism layer away from the third base material layer. In step S230, the second adhesive layer is formed on a side of the polarizing unit away from the second prism layer.

In some examples, between the step S210 and the step S220, the step of manufacturing the second composite prism film may further include: forming the first support layer and the polarizing layer that are stacked. In some other examples, between the step S210 and the step S220, the step of manufacturing the second composite prism film may further include: forming the polarizing unit including the first support layer, the polarizing layer and the second support layer that are stacked.

For the positional relationship of the polarizing unit, the second adhesive layer and the third adhesive layer, reference may be made to the related description of the positional relationship of the polarizing unit, the second adhesive layer and the third adhesive layer in Example 2.

In some examples, in step S240, the step of manufacturing the second composite prism film may further include: forming the release film on the second adhesive layer.

In step 5, the non-display surface of the second display panel is bonded to the second adhesive layer of the second composite prism film. In some examples, the release film is peeled off to expose the second adhesive layer, and the non-display surface of the second display panel is bonded to the second adhesive layer of the second composite prism film.

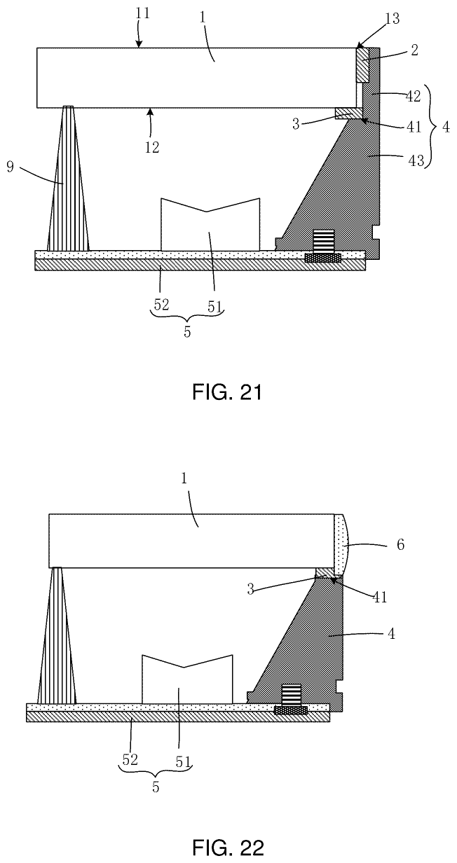

The display device will continue to be introduced hereinafter. Referring to FIGS. 21 to 24, the display module 1 below represents a full-attachment display module 1, that is, the full-attachment display module 1 may be the first display module 10 in Example 1, or the second display module 20 in Example 2.

The display device may be, for example, a display device with a borderless screen. The width of the non-display area of the display device with the borderless screen is less than or equal to 1 mm, so that the frame is extremely narrow, and the optical film(s) cannot be fixed with conventional hanging ears. Under high temperature or humidity conditions, the optical film(s) and the diffusion plate have limited expansion space, and squeeze for a long time may result in film wrinkles and other poor picture quality. For example, a direct type backlight module in a display device includes a glass diffusion plate and an optical film attached to the glass diffusion plate, which may solve the problem of expansion and fixation of the optical film.

However, the glass diffusion plate is expensive and has a relatively low light efficiency, fixation of the glass diffusion plate also needs to be considered, and the picture quality also needs to be considered. As a result, the peripheral structure of the backlight module has a very complicated design (e.g., a plurality of steps with different widths are required; alternatively, a plurality of light guide strips are required), thereby increasing the process difficulty and increasing the thickness of the backlight module and the assembly costs. In addition, the glass diffusion plate is heavy and has high stability requirements, and it is difficult to make the glass diffusion plate into ultra-light structure.

In summary, the use of the glass diffusion plate in the display device has no market advantages, and new technical solutions are needed to solve the problem.

Referring to FIG. 21, the display module 1 has a display surface 11, a back surface 12, and a side surface 13 connecting the display surface 11 and the back surface 12. The frame 4 has a first support surface 41. The back surface of the display module 1 is bonded to the first support surface 41. In this way, the display module 1 is bonded to a contact portion (i.e., the first support surface 41) of the frame 4, so that the structure of the frame 4 is simplified, which facilitates quick connection of the display module 1 and the frame 4. The first support surface 41 is parallel to a plane where the display panel is located, so that the display module 1 is relatively horizontally bonded to the first support surface 41 of the frame 4.

For example, the display device further includes a first sticking layer 3, and the first sticking layer 3 bonds the display module 1 to the first support surface 41. For example, the first sticking layer 3 may have a buffer property, and the first sticking layer 3 may be buffer foam. As another example, the first sticking layer 3 may be glue.

In some examples, the color of the first sticking layer 3 may be black, gray, or other colors with good light-shielding properties. For example, the first sticking layer 3 may be black buffer foam. The color of the first sticking layer 3 may alternatively be white or other colors with poor light-shielding properties. For example, the first sticking layer 3 may be transparent buffer foam.

In some embodiments, with continued reference to FIG. 21, the frame 4 includes a frame body 43 and a first shielding portion 42. The frame body 43 has the first support surface 41, and the first shielding portion 42 disposed on and protrudes from the frame body 43 and exposes the first support surface 41, and is provided around the side surface 13 of the display module 1. In this way, the first shielding portion 42 may shield the side surface 13 of the display module 1 to avoid light leakage.

In some examples, in a thickness direction of the display module 1, a dimension of the first shielding portion 42 is greater than or equal to a thickness of the display module 1. For example, in the thickness direction of the display module 1, a difference between the dimension of the first shielding portion 42 and the thickness of the display module 1 is greater than or equal to 0.5 mm (e.g., 0.5 mm, 1 mm, 1.5 mm or 2 mm).

In some examples, the display device further includes a second shielding portion 2. The second shielding portion 2 is bonded to the side surface of the display module 1, and the first shielding portion 42 is provided around the second shielding portion 2. In this way, the second shielding portion 2 may prevent light leakage between the display module 1 and the first shielding portion 42. For example, in a case where the second shielding portion 2 is a double-sided tape, the second shielding portion 2 may be pasted between the first shielding portion 42 and the side surface of the display module. As another example, in a case where the second shielding portion 2 is buffer foam, the second shielding portion 2 may be pasted on the display module 1, and the first shielding portion 4 is in contact with the first shielding portion 2.

In some possible implementations, the second shielding portion 2 may be glue or buffer foam. For example, the second shielding portion 2 may be black glue or black buffer foam.

In some other embodiments, referring to FIG. 22, the display device 22 further includes a third shielding portion 6. The entire frame (i.e., the entire frame shown in FIG. 22 does not have the first shielding portion 42 compared to the frame body 43 shown in FIG. 21) is located on a side of the back surface 12 of the display module 1 away from the display surface 11. The third shielding portion 6 is bonded to the side surface 13 of the display module 1, and thus light leakage of the side surface 13 of the display module 1 may be avoided. For example, the third shielding portion 6 may be black buffer foam or black glue.

In some examples, the third shielding portion 6 extends from the side surface 13 of the display module 1 to the first support surface 41. In this way, light leakage between the third shielding portion 6 and the first support surface 41 may be avoided. For example, an orthographic projection of the third shielding portion 6 on the first support surface and the first support surface 41 have an overlapping area.

The width of the first support surface 41 is smaller than a width of the non-display area of the display panel. In this way, the first support surface 41 may not block the display area of the display panel. In some examples, the display module 1 includes a pattern of black matrix. The black matrix is located in the display area and extends to the non-display area. The width of the first support surface 41 is smaller than a width of a portion of the black matrix located in the non-display area.

In some embodiments, the display device further includes a backlight layer 5. The backlight layer 5 is disposed on the frame 4 and located on a side of the back surface of the display module 1 away from the display surface. There is an air layer between the backlight layer 5 and the display module 1, and the air layer cannot change the propagation direction of the light, so that the light emitted by the backlight layer 5 may be incident on the back coating layer of the display module 1 through the air layer. Since the haze of the back coating layer in display module 1 (e.g., the first back coating layer in the first display module or the second back coating layer in the second display module) is greater than or equal to 90%, the light is diffused through the back coating layer, thereby making the display module have a rather good display picture.

For example, the backlight layer 5 may include a backplane 52 and a plurality of light-emitting devices 51.

The light-emitting device 51 is a device capable of emitting light when energized. For example, the light-emitting device 51 may be a light-emitting diode (LED), a tiny LED, a quantum dot light-emitting diode (QLED), or the like, which is not limited here. As an example, the light-emitting device 51 may be a wee light-emitting device, and the size of the wee light-emitting device may refer to the size of a tiny LED. The tiny LED includes a sub-millimeter-sized or even micrometer-sized light-emitting diode, and may also include a smaller-sized light-emitting diode. The sub-millimeter light-emitting diode is also called a mini light-emitting diode (mini LED), and the size (e.g., the length) of the mini LED may be in a range of 50 μm to 150 μm, such as in a range of 80 μm to 120 μm, or less than 100 μm. The micrometer-sized light-emitting diode is also called a micro light-emitting diode (micro LED). For example, the size (e.g., the length) of the micro LED may be less than 50 μm, such as in a range of 10 μm to 50 μm.

The plurality of light-emitting devices 51 are disposed on the backplane 52. The plurality of light-emitting devices 51 are configured to emit light toward the back surface 12 of the display module 1.

In some examples, the backlight layer 5 further includes a substrate, and the substrate may be a rigid substrate. The material of the rigid substrate may be glass, polymethyl methacrylate (PMMA), or the like. Alternatively, the substrate may be a flexible substrate. The material of the flexible substrate may be polyethylene terephthalate (PET), poly ethylene naphthalate two formic acid glycol ester (PEN), ultra-thin glass or polyimide (PI).

The plurality of light-emitting devices 51 are disposed on the substrate, and the substrate is disposed on the backplane 52. The plurality of light-emitting devices 51 are configured to emit light toward a side away from the substrate. For example, the plurality of light-emitting devices 51 are configured to emit light toward the back surface 12 of the display module 1.

A surface of the frame 4 away from the first support surface 41 is fixed on the backplane 52. For example, the frame 4 and the backplane 52 are connected by bolts.

In some examples, the backlight layer 5 may have a direct type structure. For example, the plurality of light-emitting devices 51 are distributed in an array on an upper surface of the backplane 52, and the upper surface of the backplane 52 is opposite to the back surface of the display module 1.

In some other examples, referring to FIG. 24, the backlight layer 5 may have a side type structure. The backlight layer 5 further includes a light guide plate 53, and the plurality of light-emitting devices 51 are disposed on the side surface of the frame 4. The side surface of the frame 4 intersects with the back surface 12 of the display module 1. The light emitted by the light-emitting devices 51 is transmitted to the back surface of the display module 1 through the light guide plate 53.

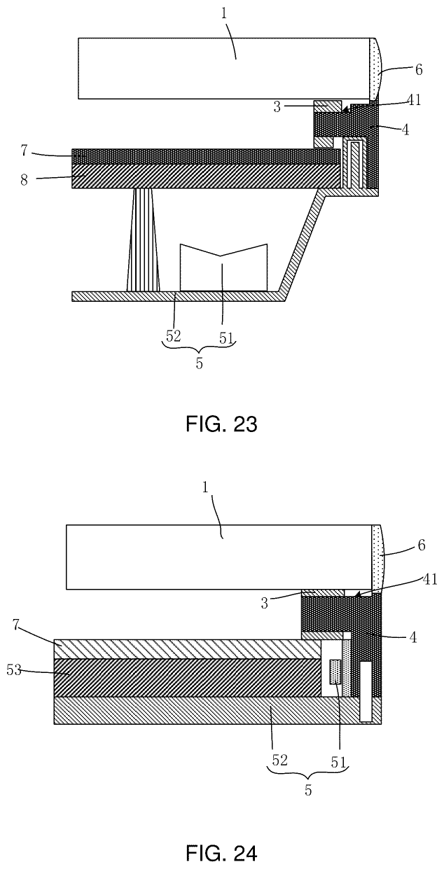

In some other embodiments, referring to FIG. 23, the display device further includes a backlight layer 5. The backlight layer 5 is disposed on the frame 4 and located on a side of the back surface 12 of the display module 1 away from the display surface 11. The display device further includes a diffusion sheet 8 disposed between the backlight layer 5 and the display module 1, so that the light emitted by the backlight layer 5 may be incident on the back coating layer of the display module 1 after being scattered by the diffusion sheet 8. Since the haze of the back coating layer in the display module (e.g., the first back coating layer in the first display module or the second back coating layer in the second display module) is in a range of 35% to 70%, the light is diffused through the back coating layer, thereby making the display module have a rather good display picture.

For example, the backlight layer 5 may include a backplane 52 and a plurality of light-emitting devices 51. A surface of the frame 4 (e.g., the middle frame) away from the first support surface 41 is fixed on the backplane 52. For example, the backlight layer 5 may have a direct type structure, which may refer to the related description of the above backlight layer 5 of the direct type structure. As another example, the backlight layer 5 may have a side type structure, which may refer to the related description of the above backlight layer 5 of the side type structure. Details are not repeated.

In some examples, the display device further includes a prism film 7. The prism film 7 is disposed between the backlight layer 5 and the display module 1. In this way, the combination of the prism layer in the display module 1 and the prism film 7 is used to improve the light efficiency of the display module 1. Referring to Table 2, the brightness gain ratio of the display device is in a range of 100% to 120% (e.g., 100%, 105%, 110%, 115% or 120%).

| | Non-full-attachment | Full-attachment | | |
|---|---|---|---|---|
| | DBEF + P | COP + P | SOP | DOP + P |
| gain ratio | 100% | 102% | 107% | 120% |

### Table 2 Shows Brightness Gain Ratios of an Existing Display Device and the Display Device in the Present Embodiments

In Table 2, the expression of “non-full-attachment” indicates a fixation manner of the display panel in the existing display device and the prism film having an air layer therebetween. Table 2 shows a case of the display device with the first display module as the display module.

DOP represents the haze layer, the first prism layer, the first base material layer and the first back coating layer (the haze is in a range of 35% to 70%). COP represents the haze layer, the polarizing brightness enhancement layer, the first prism layer, the first base material layer and the first back coating layer (the haze is in a range of 35% to 70%). SOP represents the haze layer, the polarizing brightness enhancement layer, the first prism layer, the first base material layer and the first back coating layer (the haze is in a range of 35% to 70%). VOP represents the haze layer, the polarizing brightness enhancement layer, the first prism layer, the first base material layer and the first back coating layer (the haze is in a range of 35% to 70%). P represents the prism film. The thicknesses of the polarizing brightness enhancement layers in COP, SOP and VOP increases in sequence. DBEF represents a polarizing brightness enhancement film. DOPB represents the haze layer, the first prism layer, the first base material layer and the first back coating layer, where the haze of the haze layer in DOPB is greater than the haze of the haze layer in DOP.

Since the brightness of the display device increases, the power or quantity of the light-emitting devices 51 in the backlight layer 5 may be reduced, so as to save energy and reduce consumption, thereby avoiding the temperature of the light-emitting devices 51 being too high or avoiding the EEI not meeting the standard or being too low.

In addition, the combination of the prism layer in the display module 1 and the prism film 7 may achieve the same function as the polarizing prism film in the existing display device. Therefore, the polarizing prism film in the existing display device may be replaced, thereby saving the cost.

In some examples, there is a gap between the prism film 7 and the display module 1. The gap is in a range of 1.1 mm to 2.66 mm (e.g., 1.1 mm, 1.5 mm, 1.7 mm, 2 mm, 2.3 mm, 2.5 mm, 2.6 mm or 2.66 mm) in size.

In some examples, an extending direction of the prism layer in the display module (e.g., the first prism layer in the first display module or the second prism layer in the second display module) may intersect with (e.g., being perpendicular to) an extending direction of the prism film 7.

In some examples, the display device further includes a plurality of support pillars 9. An end of the support pillar 9 is fixed on the backplane 52, and the other end thereof is in contact with the back surface 12 of the display module 1. The support pillar 9 may play a role of supporting the display module 1. For example, the support pillar 9 can be a spring-type silicone sleeve support pillar. In this way, generation of cross black lines caused by the contact between the support pillar 9 and the display module 1 may be avoided, and the display module 1 may also be supported during transportation.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

1. A display module, comprising:
a display assembly including a first display panel and a first polarizer, wherein the first polarizer is disposed on a non-display surface of the first display panel; the first display panel has a display area;
a first composite prism film including a first prism layer and a haze layer, wherein the first prism layer is disposed on a side of the first polarizer away from the first display panel;
the haze layer is disposed on the first prism layer and located between the first prism layer and the first polarizer; the haze layer includes a first bonding agent layer and a plurality of first diffusion particles dispersed in the first bonding agent layer; and
a first adhesive layer bonding the haze layer in the first composite prism film to the first polarizer in the display assembly, wherein an orthographic projection of the first adhesive layer on a plane where the first display panel is located covers at least the display area.

2. The display module according to claim 1, wherein
the plurality of first diffusion particles include a plurality of first particles, and the plurality of first particles are dispersed in the first bonding agent layer; and
in at least some of the plurality of first particles, a portion of each first particle is embedded in the first bonding agent layer, and a remaining portion of each first particle protrudes from the first bonding agent layer and is bonded to the first adhesive layer; or
the plurality of first diffusion particles include a plurality of first particles dispersed in the first bonding agent layer; in at least some of the plurality of first particles, a portion of each first particle is embedded in the first bonding agent layer, and a remaining portion of each first particle protrudes from the first bonding agent layer and is bonded to the first adhesive layer; and a ratio of a total mass of the plurality of first particles to a mass of the first bonding agent layer is greater than or equal of 60%.

3. The display module according to claim 2, wherein
the haze layer has a sampling area, an orthographic projection of the sampling area on the first display panel is located within the display area of the first display panel, and a unit length of the sampling area is at least greater than or equal to 150 μm;
the plurality of first diffusion particles further include a plurality of second particles, and the plurality of second particles are dispersed in the first bonding agent layer;
in the sampling area, a distance between a lowest first particle and the first polarizer is smaller than a distance between the second particles and the first polarizer, wherein
the lowest first particle is a first particle farthest away from the first polarizer among all the first particles protruding from an upper surface of the first bonding agent layer.

4. The display module according to claim 3, wherein
an average particle size of the plurality of first particles is greater than an average particle size of the plurality of second particles; and/or
hardness of the first particles is greater than hardness of the second particles, a total mass of the plurality of first particles is greater than a total mass of the plurality of second particles; and the hardness of the first particles is greater than or equal to 20 MPa.

5. (canceled)

6. (canceled)

7. (canceled)

8. The display module according to claim 1, wherein
a haze of the haze layer is greater than or equal to 70%, and a haze of the first adhesive layer is less than 1%.

9. The display module according to claim 1, wherein
the first display panel includes sub-pixels in a plurality of columns; and the first prism layer includes a plurality of first prism units; wherein
in a first direction, a ratio of a dimension of a first prism unit to a dimension of a sub-pixel is equal to n, n is a positive number except for 0.5 and positive integers, and the first direction is an extending direction of a long side of the first display panel; and/or
the first prism layer includes a plurality of columns of first prism units; an angle between an extending direction of the first prism units and an extending direction of a long side of the first display panel is greater than or equal to 30° and less than or equal to 150°.

10. (canceled)

11. The display module according to claim 1, wherein
the first composite prism film further includes:
a first back coating layer disposed on a side of the first prism layer away from the first display panel, the first back coating layer including a second bonding agent layer and a plurality of second diffusion particles dispersed in the second bonding agent layer; wherein a haze of the first back coating layer is greater than or equal to 90%, the second diffusion particles include sixth particles and fifth particles, a material of the sixth particles is an organic substance, and a material of the fifth particles includes a metal oxide; and a particle size of a second diffusion particle is less than or equal to 4 μm.

12. The display module according to claim 1, wherein
the first composite prism film further includes:
a first back coating layer disposed on a side of the first prism layer away from the first display panel, the first back coating layer including a second bonding agent layer and a plurality of second diffusion particles dispersed in a second bonding agent layer; wherein a haze of the first back coating layer is in a range of 35% to 70%, a material of the second diffusion particles includes an organic material, and a particle size of a second diffusion particle is in a range of 5 μm to 10 μm.

13. (canceled)

14. (canceled)

15. (canceled)

16. A display module, comprising a second display panel and a second composite prism film, the second display panel having a display area; wherein
the second composite prism film includes:
a polarizing unit disposed on a non-display surface of the second display panel and including a polarizing layer and a first support layer that are stacked;
a second adhesive layer bonding the second display panel to the polarizing unit, wherein an orthographic projection of the second adhesive layer on a plane where the second display panel is located covers at least the display area;
a second prism layer disposed on a side of the polarizing unit away from the second display panel, wherein the second prism layer has a plurality of first light exit surfaces, and the first light exit surfaces are inclined relative to the plane where the second display panel is located, and the first light exit surfaces are uneven surfaces; and
a third adhesive layer disposed between the polarizing unit and the second prism layer and bonded to the second prism layer; wherein
a haze of one of the second adhesive layer, the first support layer and the third adhesive layer is in a range of 45% to 60%, and hazes of other two are less than 1%.

17. (canceled)

18. The display module according to claim 16, wherein
the polarizing unit further includes a second support layer; the second support layer, the polarizing layer and the first support layer are stacked in sequence; and a haze of the second support layer is less than 1%.

19. The display module according to claim 16, wherein
a haze of the first light exit surfaces is in a range of 40% to 50%; and/or
a first flight exit surface has a plurality of recessed portions and/or a plurality of protrusion portions.

20. (canceled)

21. The display module according to claim 16, wherein
the second prism layer includes a plurality of second prism units, a second prism unit includes a prism body and a plurality of third diffusion particles, and the prism body has a bottom surface and inclined surfaces connected to the bottom surface; wherein
the plurality of third diffusion particles are pasted on the inclined surfaces of the prism body to become first light exit surfaces of the second prism layer.

22. The display module according to claim 21, wherein
the plurality of third diffusion particles include a plurality of third particles and a plurality of fourth particles, a material of the third particles is an organic substance, and a material of the fourth particles is a metal oxide; or
the plurality of third diffusion particles include a plurality of third particles and a plurality of fourth particles, a material of the third particles is an organic substance, and a material of the fourth particles is a metal oxide; among the plurality of third diffusion particles, a ratio of a total mass of the plurality of fourth particles to a total mass of the plurality of third particles is in a range of 30% to 50%.

23. (canceled)

24. The display module according to claim 16, wherein
the second prism layer includes a plurality of second prism units, a second prism unit has a second light exit surface and two first light exit surfaces, and the second light exit surface is connected to the two first light exit surfaces; the second light exit surface is parallel to the plane where the second display panel is located; and the second light exit surface is bonded to the third adhesive layer.

25. The display module according to claim 16, wherein
the second composite prism film further includes:
a second back coating layer disposed on a side of the second prism layer away from the second display panel; the second back coating layer including a third bonding agent layer and a plurality of fourth diffusion particles dispersed in the third bonding agent layer; a haze of the second back coating layer is greater than or equal to 90%, the fourth diffusion particles include eighth particles and seventh particles, a material of the eight particles is an organic substance, and a material of the seventh particles is a metal oxide, and a particle size of a fourth diffusion particle is less than or equal to 4 μm.

26. The display module according to claim 16, wherein
the second composite prism film further includes:
a second back coating layer disposed on a side of the second prism layer away from the second display panel; the second back coating layer including a third bonding agent layer and a plurality of fourth diffusion particles dispersed in the third bonding agent layer; wherein a haze of the second back coating layer is in a range of 35% to 70%, a material of the fourth diffusion particles is an organic material, and a particle size of a fourth diffusion particle is in a range of 5 μm to 10 μm.

27. (canceled)

28. (canceled)

29. (canceled)

30. A display device, comprising:
the display module according to claim 1; the display module having a display surface, a back surface, and a side surface connecting the display surface and the back surface; and
a frame having a first support surface; the back surface of the display module being bonded to the first support surface; wherein
the first support surface is parallel to the plane where the display panel is located.

31. The display device according to claim 30, wherein
the frame includes a frame body and a first shielding portion; the frame body has the first support surface; the first shielding portion is disposed on and protrudes from the frame body, exposes the first support surface, and surrounds the side surface of the display module; or
the entire frame is located on a side of the back surface of the display module away from the display surface; and the display device further comprises a third shielding portion bonded to the side surface of the display module.

32. (canceled)

33. (canceled)

34. (canceled)

35. (canceled)

36. (canceled)

37. The display device according to claim 30, further comprising:
a backlight layer disposed on the frame and located on a side of the back surface of the display module away from the display surface; wherein
the display module further includes a back coating layer disposed on a side of the first prism layer away from the first display panel; the backlight layer and the display module have an air layer therebetween, and a haze of the back coating layer in the display module is greater than or equal to 90%; or the display device further includes a diffusion sheet disposed between the backlight layer and the display module, and the haze of the back coating layer in the display module is in a range of 35% to 70%.

38. (canceled)

39. A display device, comprising:
the display module according to claim 16; the display module having a display surface, a back surface, and a side surface connecting the display surface and the back surface; and
a frame having a first support surface; the back surface of the display module being bonded to the first support surface; wherein
the first support surface is parallel to the plane where the display panel is located.
